(19) United States
(12) Patent Application Publication
(10) Pub. No.: US 2007/0196787 A1
(43) Pub. Date: Aug. 23, 2007

(54) Method of applying a denture adhesive

(75) Inventors: Alfred J. Smetana, Wayne, NJ (US); Stuart B. Wilensky, Parsippany, NJ (US)

Correspondence Address: SMITHKLINE BEECHAM CORPORATION;CORPORATE INTELLECTUAL PROPERTY-US, UW2220, P. O. BOX 1539, KING OF PRUSSIA, PA, 19406-0939, US

(73) Assignee: SMITHKLINE BEECHAM CORPORATION CORPORATE INTELLECTUAL PROPERTY - U.S. UW2220, KING OF PRUSSIA, PA (US)

(21) Appl. No.: 10/590,068

(22) PCT Filed: Feb. 23, 2005
(86) PCT No.: PCT/US05/05622

§ 371 Date: Aug. 21, 2006

Related U.S. Application Data
(60) Provisional application No. 60/546,728, filed on Feb. 23, 2004.

(51) Int. Cl. A61C 13/225; A61C 13/00

(52) U.S. Cl. 433/180; 433/167

(57) ABSTRACT

A method of reducing the time to reach maximum adhesivity of a denture adhesive to providing rapid hold of a denture to the oral cavity of an individual.

### FIELD OF THE INVENTION

The present invention relates to a method of reducing the time to reach maximum adhesivity of a denture adhesive to provide rapid hold of a denture in the oral cavity of an individual.

### BACKGROUND OF THE INVENTION

Dentures and dental plates function as a substitute for all or part of missing teeth ordinarily found in the mouth. While dentures are usually carefully fitted for the user, the fit can change over time, due to natural shrinkage and changes in the gum or mucosal tissue, causing discomfort and slippage. To alleviate the discomfort and to control the slippage, a denture adhesive may be applied to the denture to fill the interstices between the dentures and the gum or tissues. Sometimes referred to as a denture stabilizer, the denture adhesive is formulated not only for its adherent properties, but also to provide a cushion or gasket between the denture and the gums or tissues, thereby positioning the denture securely in the oral cavity. By producing a more secure fit of the denture a barrier is created preventing food particles from becoming lodged in between the denture and the mucosal tissue.

Common forms of the denture adhesive, or stabilizer, include denture adhesive creams, powders, gels and liners. Generally, these denture adhesive products comprise a sealing or gasket-forming material that is typically a water swellable gum or polymer. The gum or polymer hydrates and becomes tacky when introduced to the saliva in the oral cavity, thus holding the dentures in place.

Those products currently available typically instruct the consumer to dry the denture upon cleansing and prior to the application of any denture adhesive product. The consumer is further instructed to insert the dry, adhesive coated denture into the oral cavity and situate the denture in place, without prior rinsing. It has not been recognized that the process of applying the denture adhesive and securing the denture in place can be more effective when performed with the introduction of additional water to the system.

### SUMMARY OF THE INVENTION

The present invention relates to a method of reducing the time to reach maximum adhesivity of a denture adhesive to provide a more rapid hold of a denture to the oral cavity of an individual without negatively effecting the length or extent of hold ultimately achieved. The method comprises the steps of applying denture adhesive to said denture; wetting the denture and inserting said denture in place in the mouth. An alternative method comprises the steps of wetting a denture, applying denture adhesive to said denture; and inserting said denture in the mouth. A third embodiment comprises the steps of wetting a denture, applying denture adhesive to said denture; rewetting the denture; and inserting said denture in place in the mouth. Wetting the denture before and/or after application of the denture adhesive and prior to insertion into the mouth has been found to reduce the speed to maximum adhesivity of the denture adhesive without negatively effecting other properties of the adhesive.

### BRIEF DESCRIPTION OF THE DRAWINGS

FIG. 1 is a graph indicating the results of dislodge force studies comparing the dislodge force of a denture adhesive cream when the adhesive is applied to a pre-wetted denture versus application of the denture adhesive cream to a dry denture as measured at 5 minutes post application.

### DETAILED DESCRIPTION OF THE INVENTION

The present invention relates to a method of reducing the time to reach maximum adhesivity of a denture adhesive to produce stronger hold of the denture to the oral cavity faster, without negatively effecting other properties of the denture adhesive. The method comprises the steps of applying denture adhesive to said denture; wetting the denture and inserting said denture in place in the mouth. An alternative method comprises the steps of wetting a denture, applying denture adhesive to said denture; and inserting said denture in the mouth. A third embodiment comprises the steps of wetting a denture, applying denture adhesive to said denture; rewetting the denture; and inserting said denture in place in the mouth. In certain embodiments, the method may further comprise the step of rinsing the mouth with water at any point in the method, prior to inserting the denture in place in the mouth.

As used herein the term “maximum adhesivity” means the maximum force, measured in pounds, necessary to dislodge a denture from the oral cavity after the application of a denture adhesive product measured at the time the adhesive component of the denture adhesive product has been fully activated.

The denture adhesive used may be any denture adhesive known in the art that comprises an adhesive polymer system wherein the adhesive polymer system includes as least one water activated adhesive hydrophilic colloid or polymer. Water activated, as used herein, means that the hydrophilic colloid or polymer swells to form a mucilaginous mass upon exposure to water. Water activated adhesive hydrophilic colloids and polymers include, but are not limited to; mixed partial salts of alkyl vinyl ether maleic acid or anhydride copolymers (AVE/MA) comprising alkaline cations selected from the group of calcium, strontium, sodium, zinc, magnesiun, iron (II), potassium, and zirconium oxy cations; xanthan gum; karaya gum; guar gum; acacia gum; chitosan; gelatin; algins; agar; sodium alginate; tragacanth; polyethylene glycol (PEG); acrylamide polymers; carbopol; polyvinyl alcohol; polyvinyl acetate; polyamines; polyquarternary compounds; polybutenes; silicones; ethylene oxide polymers; polyvinylpyrrolidone (PVP); cationic polyacrylamide polymers; methylcellulose; sodium carboxymethylcellulose; hydroxy ethylcellulose (HEC); hydroxy propylcellulose (HPC); hydroxy propyl methylcellulose (HPMC); and carboxymethylcellulose. Suitable mixed partial salts of AVE/MA include triple salts such as magnesium/zinc/sodium salt and double salts such as the calcium/sodium salt and the calcium/zinc salt. Examples of denture adhesive compositions that include at least one water activated denture adhesive polymer are more particularly described in U.S. Pat. Nos. 4,758,630; 4,880,702; 5,073,604; 5,093,387; 5,266,624; 5,304,616; 5,424,058; 5,395,867; 5,543,443; 5,763,554; 5,872,160; 5,877,233; 5,880,172; 5,900,470; 6,069,188; 6,080,811; 5,525,652; 5,696,181; 5,750,591; 5,830,933; 6,025,411; 6,124,374; 6,166,102; 6,239,191; 6,423,762 and in published patent applications WO 92/10988; WO 92/10987; WO 92/22280; WO 95/33435; WO 98/43594; WO 98/01103; WO 96/04883, incorporated herein by reference.

The following examples further describe and demonstrate certain formulations wherein the application of the instant methods can be useful. These examples are given solely for the purpose of illustration and are not to be construed as limitations of the present method. Many variations of these formulations are possible to which the present methods are still readily applicable.

### EXAMPLES 1-3

### Cream and Gel Adhesive Formulation

| Component in % wt/wt | Ex. 1 | Ex. 2 | Ex. 3 |
|---|---|---|---|
| MVE/MA* Na/Mg/Zn Salt | 30 | 25 | |
| Polyethylene oxide | | | 13 |
| Sodium Carboxymethylcellulose | 24 | 20 | 32 |
| Mineral Oil | 16 | 16 | 11.95 |
| Petrolatum | 26.25 | 37.08 | 41.82 |
| Flavor, spray dried | 1.6 | | 0.4 |
| Colloidal Silicon Dioxide | 1.1 | 1.1 | |
| MVE/MA | 1 | 0.82 | |
| Lake Dye Paste | 0.05 | | 0.68 |
| Preservative | | | 0.05 |
| Buffering agent | | | 0.1 |
| Total | 100 | 100 | 100 |

*Poly methyl vinyl ether/maleic acid

### EXAMPLES 4-5

### Powder Adhesive Formulations

| Component in % wt/wt | Ex. 4 | Ex. 5 |
|---|---|---|
| MVE/MA Na/Ca Salt | 49.8 | |
| Carboxymethylcellulose sodium | 49.8 | 49 |
| Polyethylene oxide | | 21 |
| Dicalcium phosphate anhydrous | | 29.4 |
| Flavor, spray dried | 0.4 | 0.4 |
| Buffering agent | | 0.2 |
| Total | 100 | 100 |

### EXAMPLES 6-12

### Denture Adhesive Liner Formulations

| Component in % wt/wt | Ex. 6 | Ex. 7 | Ex. 8 | Ex. 9 | Ex. 10 | Ex. 11 | Ex. 12 |
|---|---|---|---|---|---|---|---|
| Polyethylene oxide | 0 | 5 | 0 | 0 | 0 | 5.0 | 0.0 |
| Hydroxypropylcellulose | 78.3 | 70.8 | 93.3 | 78.3 | 78.3 | 65.8 | 75.8 |
| MVE/MA Na/Mg/Zn lysine Salt | 0 | 0 | 0 | 0 | 15 | 0.0 | 0.0 |
| MVE/MA Na/Mg/Zn Salt | 0 | 0 | 0 | 15 | 0 | 0.0 | 0.0 |
| MVE/MA Na/Ca Salt | 15 | 15 | 0 | 0 | 0 | 15.0 | 0.0 |
| Carboxymethylcellulose sodium | 0 | 2.5 | 0 | 0 | 0 | 0.0 | 0.0 |
| Alginic acid | 0 | 0 | 0 | 0 | 0 | 7.5 | 17.5 |
| Silicon Dioxide | 2.5 | 2.5 | 2.5 | 2.5 | 2.5 | 2.5 | 2.5 |
| Preservative | 0.2 | 0.2 | 0.2 | 0.2 | 0.2 | 0.2 | 0.2 |
| Plasticizer | 4 | 4 | 4 | 4 | 4 | 4.0 | 4.0 |
| Total | 100 | 100 | 100 | 100 | 100 | 100.00 | 100.00 |

In order to determine the effectiveness of the present method on reducing the time to reach maximum adhesivity, a dislodge force test was performed. The test determined the dislodge force of a denture that was pre-wetted prior to application of a denture adhesive cream and the dislodge force of a denture that was dried prior to the application of the denture adhesive and not wetted prior to insertion in the mouth. The dislodge force, measured in pounds, was recorded at time=0 and time=5 minutes.

The wet sample was prepared by placing a piece of Alpha B Cloth (chamois) onto an acrylic plate. The cloth was then moistened with water and the denture adhesive cream was placed on four areas of the cloth. The dry sample was prepared by placing a piece of Alpha B Cloth (chamois) onto an acrylic plate. The denture adhesive cream was placed on four areas of the dry cloth in the same manner as described above. In each instance, the total weight of the cream was 0.50 g. The results of that testing, reported as lbs. of force, follow:

| Time (Min) | Run #1 | Run #2 | Run #3 | Run #4 | Run #5 | Run #6 | Run #7 | Run #8 |
|---|---|---|---|---|---|---|---|---|
| Pre-Wetted | | | | | | | | |
| Denture | | | | | | | | |
| 0 | 0 | 0 | 0 | 0 | 0 | 0 | 0 | 0 |
| 5 | 4.88 | 7.6 | 7.6 | 9.72 | 8.58 | 7.56 | 8.94 | 8.34 |
| Dry Denture | | | | | | | | |
| 0 | 0 | 0 | 0 | 0 | 0 | 0 | 0 | 0 |
| 5 | 5.52 | 6.48 | 6.24 | 6.56 | 3.12 | 6.06 | 4.9 | 3.82 |

Peak Values for 12 readings.

Eight runs were completed with readings taken at time=0 and time =5 minutes. The test results indicate that there is a statistically significant difference favoring the “wet” sample over the “dry”. The average force for the “wet” sample was 7.90 lbs. The average force for the “dry” sample was 5.34 lbs.

A bite force test was conducted on denture adhesive creams in which methods of application were compared. Hydrating the denture before or after application of the adhesive combined with oral rinsing prior to insertion of the denture was studied for their effect on hold for up to 6 hours later. Bite force readings were taken at baseline and at 0.5, 1, 3, and 6 hours after the application of adhesive. All subjects wore full upper dentures. The sample size was based on subject availability.

There were significant differences in hold observed at the half-hour time point (Table 1). Conditions involving rinsing the mouth prior to inserting the denture produced a lower mean bite force compared to conditions in which the denture was moist at the time of application or moisture was added directly to the denture after application prior to insertion. This difference was most significant when application of adhesive to a dry denture was combined with mouth rinsing.

There appears to be some quick-hold benefit to hydrating an application of a denture adhesive, either by applying the adhesive to a moistened denture or wetting the denture after application. In contrast, rinsing the mouth resulted in a lower mean hold in the first half-hour of use. By the end of 6 hours, initial wetting conditions did not affect hold differentially.

The results of the bite force test are included below:

TABLE 1
Least Squares Means and Standard Errors by Treatment
at Baseline and Each Time After Application
With P-Values from LSD Tests on Comparisons of Interest

| | | Base- | | | | | 16 h |
|---|---|---|---|---|---|---|---|
| (N = 11) | | line | 0.5 h | 1 h | 3 h | 6 h | AUC |
| DRY/ | LS Mean | 1.62 | 8.10 | 8.63 | 8.71 | 8.95 | 43.8 |
| NO RINSE | LS Std. Err. | 0.06 | 0.30 | 0.23 | 0.20 | 0.28 | 2.2 |
| Dry | P-Value vs.: | | | | | | |
| Denture, No | Dry/Rinse | 0.16 | 0.03 | 0.45 | 0.72 | 0.91 | 0.89 |
| Rinsing | Dry/Wet | 0.01 | 0.09 | 0.92 | 0.11 | 0.88 | 0.74 |
| | Wet/Rinse | 0.85 | 0.66 | 0.53 | 0.80 | 0.30 | 0.84 |
| | Wet/No rinse | 0.03 | 0.11 | 0.29 | 0.08 | 0.90 | 0.75 |
| DRY/ | LS Mean | 1.74 | 7.21 | 8.38 | 8.61 | 9.00 | 43.4 |
| RINSE | LS Std. Err. | 0.06 | 0.29 | 0.23 | 0.20 | 0.27 | 2.13 |
| Dry | P-Value vs.: | | | | | | |
| Denture, | Dry/Wet | 0.05 | 0.01 | 0.39 | 0.19 | 0.96 | 0.84 |
| Mouth Rinse | Wet/Rinse | 0.22 | 0.01 | 0.90 | 0.54 | 0.25 | 0.95 |
| Before | Wet/No rinse | 0.44 | 0.01 | 0.75 | 0.03 | 0.99 | 0.64 |
| Insertion | | | | | | | |
| DRY/WET | LS Mean | 1.92 | 8.83 | 8.66 | 8.24 | 9.02 | 42.8 |
| Dry Denture/ | LS Std. Err. | 0.06 | 0.30 | 0.24 | 0.20 | 0.28 | 2.2 |
| Wet | P-Value vs.: | | | | | | |
| Denture | Wet/Rinse | 0.01 | 0.20 | 0.48 | 0.06 | 0.25 | 0.90 |
| After | Wet/No rinse | 0.24 | 0.90 | 0.24 | 0.01 | 0.98 | 0.51 |
| Application | | | | | | | |
| WET/ | LS Mean | 1.64 | 8.28 | 8.42 | 8.78 | 8.55 | 43.2 |
| RINSE | LS Std. Err. | 0.06 | 0.30 | 0.23 | 0.20 | 0.28 | 2.2 |
| Wet | P-Value vs.: | | | | | | |
| Denture, | Wet/No rinse | 0.05 | 0.24 | 0.65 | 0.12 | 0.25 | 0.60 |
| Mouth Rinse | | | | | | | |
| Before | | | | | | | |
| Insertion | | | | | | | |
| WET/ | LS Mean | 1.81 | 8.77 | 8.27 | 9.22 | 9.01 | 44.8 |
| NO RINSE | LS Std. Err. | 0.06 | 0.29 | 0.23 | 0.20 | 0.28 | 2.2 |
| Wet | | | | | | | |
| Denture, No | | | | | | | |
| Rinsing | | | | | | | |

What is claimed is:

1. A method of increasing the rate by which maximum adhesivity of a denture adhesive is achieved comprising the steps of:
(a) applying a denture adhesive to a denture;
(b) wetting said denture after application of the denture adhesive to the denture; and
(c) inserting said denture in the mouth.

2. The method of claim 1 wherein the denture adhesive is in the form of a cream, gel, powder or liner.

3. A method of increasing the rate by which maximum adhesivity of a denture adhesive is achieved comprising the steps of:
(a) wetting a denture,
(b) applying denture adhesive to said denture; and
(c) inserting said denture in the mouth.

4. The method of claim 3 wherein the denture adhesive is in the form of a cream, gel, powder or liner.

5. A method of increasing the rate by which maximum adhesivity of a denture adhesive is achieved comprising the steps of:
(a) wetting a denture;
(b) applying denture adhesive to said denture;
(c) rewetting the denture after application of the denture adhesive to the denture; and
(d) inserting the denture in place in the mouth.

6. The method of claim 5 wherein the denture adhesive is in the form of a cream, gel, powder or liner.
